(19) United States
(12) Patent Application Publication
(10) Pub. No.: US 2026/0063359 A1
(43) Pub. Date: Mar. 5, 2026

(54) LIQUEFACTION OF NATURAL GAS FEEDS CONTAINING HYDROGEN

(71) Applicant: Honeywell LNG LLC, Allentown, PA (US)

(72) Inventors: Mark Julian Roberts, Whitehall, PA (US); Katherine Bannister Wells, Macungie, PA (US); Annemarie Ott Weist, Macungie, PA (US); Christopher G. Elko, Allentown, PA (US); Justin David Bukowski, Hamburg, PA (US); Christopher Michael Ott, Macungie, PA (US)

(21) Appl. No.: 19/108,292

(22) PCT Filed: Aug. 31, 2023
(86) PCT No.: PCT/US2023/031634

§ 371 Date: Mar. 3, 2025

Related U.S. Application Data
(60) Provisional application No. 63/403,564, filed on Sep. 2, 2022.

(51) Int. Cl. F25J 3/02

(52) U.S. Cl. CPC F25J 3/0252; F25J 3/0209; F25J 3/0233; F25J 3/0295; F25J 2205/50; F25J 2205/80; F25J 2245/02; F25J 2260/00

(57) ABSTRACT

Liquefaction systems and methods are disclosed that are adapted to process a natural gas stream having a substantial concentration of hydrogen and where the concentration of hydrogen may vary in the natural gas stream. In some implementations, an expanded liquefied natural gas stream may be separated into a hydrogen enriched endflash stream and a hydrogen depleted LNG stream, and a second gaseous hydrogen depleted stream may be produced from the hydrogen enriched endflash stream and/the hydrogen depleted LNG stream. In other implementations, the pressure of the endflash compressor may be controlled for the purpose of maintaining a hydrogen concentration in a fuel stream (often the endflash stream) within a desired range. Some implementations may include pre- or post-liquefaction purification using, for example, membranes, adsorption, partial condensation, distillation, stripping, and electrochemical membranes.

### BACKGROUND

Blending green or blue hydrogen into existing natural gas pipelines is being discussed and studied globally as a path toward a lower carbon footprint. Blue hydrogen is formed by reacting natural gas into hydrogen and carbon dioxide (“CO2”) by methods such as steam methane reforming (“SMR”) or auto thermal reforming (“ATR”) and with the CO2 being captured and then stored. Green hydrogen is produced by electrolyzing water with renewable energy. One vision includes producing green hydrogen and injecting this hydrogen into nearby natural gas pipelines. In essence, these pipelines will serve as storage and a conduit for renewable energy.

Many countries are looking at hydrogen blending as an intermediate step in the journey to “Net Zero Carbon by 2050.” The United States Department of Energy has commissioned studies on the effects of hydrogen blending on metallurgy and leak rates. Various resources have suggested up to 20% of hydrogen could be blended into natural gas without negatively affecting piping metal and downstream appliances. The California Public Utilities Commission has studied hydrogen blending and has determined that up to 5% hydrogen blend is generally safe and acknowledges there is a greater chance of pipeline leaks and the embrittlement of steel pipelines with hydrogen blending. Some utility companies are beginning small trials. It is also likely that the hydrogen concentration in the natural gas pipelines will vary over time.

If these proposals are implemented, they can impose significant costs and challenges for liquified natural gas (“LNG”) production plants that draw from pipelines having hydrogen blending. It is not feasible to liquefy the hydrogen into the LNG product at concentrations above several hundred parts per million (“PPM”). Hydrogen can be rejected from the natural gas feed to a fuel stream for gas turbine drivers or other uses but would be present in the fuel stream at concentrations that are many multiples of that in the natural gas feed. Because hydrogen has different thermophysical properties than natural gas, its presence in a fuel stream for gas turbine drivers will result in operational impacts to the fuel flow, fuel compressor, burner flame characteristics, and NOx emissions. Many gas turbine drivers will require significant modifications to operate using a fuel stream having a hydrogen concentration higher than 20-30%. The potential variability of hydrogen concentration in the natural gas pipeline presents challenges for fuel balance in LNG plants. Accordingly, there is a need for innovative solutions to effectively enable natural gas feed with hydrogen blending to be used in an LNG plant.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Several aspects of the systems and methods are outlined below.

Referring to FIG. 1, the disclosed illustrative embodiments satisfy the need in the art by providing several LNG systems 100 in which the feed stream 110 is a blended hydrogen natural gas feed stream. Downstream from liquefaction, a gaseous hydrogen enriched stream 114 is produced, which may be used as fuel, exported (e.g., to the source pipeline or another pipeline), or further purified to create a purified hydrogen stream. The gaseous hydrogen enriched stream 114 is a mixture primarily of methane, nitrogen, and hydrogen and has a higher concentration of hydrogen than the blended hydrogen natural gas feed stream 110. A gaseous hydrogen depleted stream 112 is also produced, which may be recycled to the feed stream 110. The gaseous hydrogen-depleted stream 112 is a mixture primarily of methane, nitrogen and hydrogen and has a lower concentration of hydrogen than the blended hydrogen natural gas feed stream. As is conventional, an LNG product stream is also produced, which is preferably depleted in hydrogen relative to the blended hydrogen natural gas feed stream 110.

Several aspects of the systems and methods are

Aspect 1: A method comprising:
(a) cooling and liquefying a hydrogen-containing natural gas feed stream in a natural gas liquefaction plant to form a liquefied natural gas stream;
(b) reducing the pressure of the liquefied natural gas stream to form an expanded LNG stream;
(c) separating the expanded LNG stream into a first endflash stream and a hydrogen-depleted LNG stream in a first endflash unit, the first endflash stream having a higher concentration of hydrogen than the hydrogen-containing natural gas feed stream, the hydrogen-depleted LNG stream having a lower concentration of hydrogen than the hydrogen-containing natural gas feed stream; and
(d) further processing the first endflash stream and/or the hydrogen-depleted LNG stream to form a gaseous depleted hydrogen stream and a gaseous enriched hydrogen stream.

Aspect 2: The method of Aspect 1, wherein step (d) is performed using at least one selected from the group of: at least one membrane stage, at least one adsorption stage, a partial condensation stage, a distillation stage, a stripping stage, and an electrochemical membrane stage.

Aspect 3: The method of any of Aspects 1-2, wherein the first endflash unit is a vapor liquid separator.

Aspect 4: The method of any of Aspects 1-2, wherein the first endflash unit is a distillation column.

Aspect 5: The method of any of Aspects 1-4, further comprising:
(e) compressing the gaseous enriched hydrogen stream and using it as a fuel stream.

Aspect 6: The method of Aspect 5, wherein the fuel stream is for a gas turbine, a boiler, or a fired heater.

Aspect 7: The method of any of Aspects 1-6, further comprising:
(f) further processing the gaseous enriched hydrogen stream to form a purified hydrogen stream having a hydrogen concentration of at least 90%.

Aspect 8: The method of Aspect 7, further comprising:
(g) sending the purified hydrogen stream to a fuel cell to make electricity.

Aspect 9: The method of Aspect 7, further comprising:
(h) sending the purified hydrogen stream to a hydrogen pipeline.

Aspect 10: The method of any of Aspects 1-9, further comprising:
(i) sending at least a portion of the gaseous depleted hydrogen stream to a fuel stream.

Aspect 11: The method of any of Aspects 1-10, further comprising:
(j) sending at least a portion of the gaseous depleted hydrogen stream to a recycle stream that is combined with the hydrogen-containing natural gas feed stream upstream from step (a).

Aspect 12: The method of any of Aspects 1-11, further comprising:
(k) controlling the separator pressure at which step (c) is performed in order to maintain a concentration of hydrogen in the first endflash stream within a first predetermined range.

Aspect 13: The method of Aspect 1, further comprising:
(l) pretreating the hydrogen-containing natural gas feed stream upstream from step (a) to produce a pretreated hydrogen-containing natural gas feed stream and a hydrogen enriched pretreatment stream, the pretreated hydrogen-containing natural gas feed stream having a lower concentration of hydrogen than the hydrogen-containing natural gas feed stream.

Aspect 14: The method of Aspect 13, further comprising:
(m) sending the hydrogen enriched pretreatment stream to a fuel stream.

Aspect 15: The method of any of Aspects 13-14, further comprising:
(n) performing step (a) on the pretreated hydrogen-containing natural gas feed stream.

Aspect 16: The method of Aspect 13, further comprising:
(o) purifying the hydrogen enriched pretreatment stream to form a purified hydrogen stream having a hydrogen concentration of at least 90%.

Aspect 17: The method of Aspect 16, further comprising performing step (o) using at least one adsorption bed.

Aspect 18: A method comprising:
(a) cooling and liquefying a hydrogen-containing natural gas feed stream in a natural gas liquefaction plant having at least one gas turbine-driven refrigeration compressor to form a liquefied natural gas stream;
(b) using a fuel stream to drive the at least one of the at least one gas turbine-driven refrigeration compressor;
(c) reducing the pressure of the liquefied natural gas stream to form an expanded LNG stream;
(d) separating the expanded LNG stream into an endflash stream and a hydrogen-depleted LNG stream in an endflash separator, the endflash stream having a higher concentration of hydrogen that the hydrogen-containing natural gas feed stream;
(e) compressing the endflash stream to form a compressed endflash stream;
(f) storing the hydrogen-depleted LNG stream in an LNG storage tank;
(g) compressing a BOG stream from the LNG storage tank to form a compressed BOG stream;
(h) further compressing the compressed bog stream to form a further compressed BOG stream; and
(i) combining the further compressed BOG stream with the hydrogen-containing natural gas feed stream upstream from the performance of step (a);
wherein the fuel stream comprises the compressed endflash stream.

Aspect 19: The method of Aspect 18, further comprising:
(j) diverting a first portion of the BOG stream upstream from step (h); and
(k) combining the first portion of the BOG stream with the endflash stream to form the fuel stream.

Aspect 20: A method comprising:
(a) cooling and liquefying a hydrogen-containing natural gas feed stream in a natural gas liquefaction plant to form a liquefied natural gas stream;
(b) reducing the pressure of the liquefied natural gas stream to form an expanded LNG stream;
(c) separating the expanded LNG stream into a first endflash stream and a hydrogen-depleted LNG stream in a first endflash unit, the first endflash stream having a higher concentration of hydrogen than the hydrogen-containing natural gas feed stream, the hydrogen-depleted LNG stream having a lower concentration of hydrogen than the hydrogen-containing natural gas feed stream;
(d) compressing the endflash stream using an endflash compressor to form a compressed endflash stream;
(e) using the compressed endflash stream as a fuel stream; and
(f) controlling the pressure at which the endflash compressor is operated to maintain a hydrogen concentration in the fuel stream within a predetermined range.

For electric motor-driven plants drawing power from the grid and with low fuel demand, hydrogen rejection is required. This can be accomplished at the cold end of the plant in an endflash system. This system can be designed to produce an export stream containing greater than 50% hydrogen. The hydrogen can also be removed from the front end of the plant using many separation schemes. Front-end removal of hydrogen, however, requires processing of the whole feed stream, while removing hydrogen from the backend involves processing on the flash stream which is a small fraction of the total feed stream.

For gas turbine-driven plants where the feed hydrogen content exceeds approximately 0.5% and the hydrogen is sent to fuel, the endflash stream will be enriched in hydrogen and modifications will be required to the existing endflash compression system. For feeds containing greater than 2% hydrogen, the fuel stream will be highly enriched in hydrogen and significant modifications will be required to the gas turbine combustion and fuel systems if hydrogen is not exported. There are many possible schemes for producing a hydrogen/methane mixture appropriate for export. The optimal scheme will depend on the destination of the export stream. If there is a local market demand for hydrogen, exported hydrogen from the LNG plant can be further processed into a saleable product.

### BRIEF DESCRIPTION OF THE DRAWING(S)

The exemplary illustrations will hereinafter be described in conjunction with the appended drawing figures wherein like numerals denote like elements.

FIG. 1 is a schematic flow diagram depicting three streams created from a blended hydrogen natural gas feed stream in an LNG plant;

FIG. 2 is a schematic flow diagram depicting an LNG plant having no flowsheet modification from the prior art;

FIG. 3 is a schematic flow diagram depicting an LNG plant with a boil off gas (“BOG”) recycle compressor added to recycle low-hydrogen-content BOG and storage tank flash to the feed;

FIG. 4 is a schematic flow diagram depicting an LNG plant depicting the removal of hydrogen to fuel using a back end membrane;

FIG. 5 is a schematic flow diagram depicting an LNG plant having a double endflash configuration;

FIG. 6 is a graph showing the maximum production available from the exemplary implementations shown in FIGS. 2 through 5 as a function of feed hydrogen content ranging from 0 to 5%;

FIG. 7 is a graph showing specific power requirements for the exemplary implementations shown in FIGS. 2 through 5 as a function of feed hydrogen content ranging from 0 to 5%;

FIG. 8 is a schematic flow diagram depicting an LNG plant showing endflash H2 separation;

FIG. 9 is a table showing modeled system parameters for the exemplary implementation of FIG. 8;

FIG. 10 is a schematic flow diagram depicting an LNG plant having a front-end membrane;

FIG. 11 is a schematic flow diagram depicting an LNG plant having a front-end membrane and further purification of the permeate stream using adsorption; and

FIG. 12 is the LNG plant shown in FIG. 11, modified to provide dual endflash.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention.

In order to aid in describing the invention, directional terms may be used in the specification and claims to describe portions of the present invention (e.g., upper, lower, left, right, etc.). These directional terms are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

Unless otherwise indicated, the articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “conduit,” as used in the specification and claims, refers to one or more structures through which fluids can be transported between two or more components of a system. For example, conduits can include pipes, ducts, passageways, and combinations thereof that transport liquids, vapors, and/or gases.

The term “natural gas”, as used in the specification and claims, means a hydrocarbon gas mixture consisting primarily of methane. As used herein, the term “natural gas” also encompasses synthetic and substitute natural gases. The natural gas feed stream comprises methane and nitrogen (with methane typically being the major component).

The terms “hydrogen-containing natural gas” and “hydrogen-containing natural gas stream”, as used in the specification and claims, mean a natural gas stream containing at least 100 ppm hydrogen. The terms “hydrogen-containing natural gas” and “hydrogen-containing natural gas stream” are intended to be synonymous with the term “blended hydrogen natural gas stream”.

Unless otherwise stated herein, any and all percentages identified in the specification, drawings, and claims should be understood to be on a mole percentage basis. Unless otherwise stated herein, any and all pressures identified in the specification, drawings, and claims should be understood to mean gauge pressure.

As used in the specification and claims, the term “compression system” is defined as one or more compression stages. For example, a compression system may comprise multiple compression stages within a single compressor. In an alternative example, a compression system may comprise multiple compressors.

In the claims, letters are used to identify claimed steps (e.g. (a), (b), and (c)). These letters are used to aid in referring to the method steps and are not intended to indicate the order in which claimed steps are performed, unless and only to the extent that such order is specifically recited in the claims.

The term “membrane module”, as used in the specification and claims, means a device that is used to selectively separate gases by flowing, at a relatively high pressure, a feed gas through one or more conduits contained within a shell (also referred to as a high-pressure side). The conduits are at least partially defined by a membrane material that provides a barrier between each conduit and a shell space (also referred to as a low-pressure side). The shell space is an internal volume within the shell and external to each of the membranes that is maintained at a relatively low pressure. The shell side is in fluid flow communication with a permeate port, through which gas that permeates the membrane(s) exits the shell. Optionally, a sweep port may also be provided, which supplies a sweep gas to the shell space and assists the flow of permeate gas through the permeate port. The membrane material is chosen to enable one or more gases in the feed stream (referred to as the permeate gas) to pass through the membrane material at a higher rate than other gas(es) in the feed gas stream (referred to as the non-permeate or product gas). The membrane module may be of a bore-side feed design wherein the membrane module is pressurized by introduction of a feed gas stream into its bore side or may be of a shell-side feed design wherein the membrane module is pressurized by introduction of the feed gas stream into its shell side.

Where used herein to identify recited features of a method or system, the terms “first,” “second,” “third,” and so on, are used solely to aid in referring to and distinguishing between the features in question and are not intended to indicate any specific order of the features, unless and only to the extent that such order is specifically recited.

As used herein, the term “fuel stream” means a gaseous stream that is used to provide fuel for a part of an LNG plant, such as a gas turbine or steam generation system such as a boiler, fired heater, or other combustion device.

As used herein, reference to a product stream from a gas separation process being “enriched” in a particular gas or component means that the product stream has a higher mole % of said particular gas or component than the supply stream to the gas separation process. Non-limited examples of fluid separation processes include separation drums, distillation columns, stripping columns, adsorption, membrane separation, and electrochemical separation.

As used herein, the term “fluid flow communication” refers to the nature of connectivity between two or more components that enables liquids, vapors, and/or two-phase mixtures to be transported between the components in a controlled fashion (i.e., without leakage) either directly or indirectly. Coupling two or more components such that they are in fluid flow communication with each other can involve any suitable method known in the art, such as with the use of welds, flanged conduits, gaskets, and bolts. Two or more components may also be coupled together via other components of the system that may separate them, for example, valves, gates, or other devices that may selectively restrict or direct fluid flow. As used herein, the term “conduit” refers to one or more structures through which fluids can be transported between two or more components of a system. For example, conduits can include pipes, ducts, passageways, and combinations thereof that transport liquids, vapors, and/or gases.

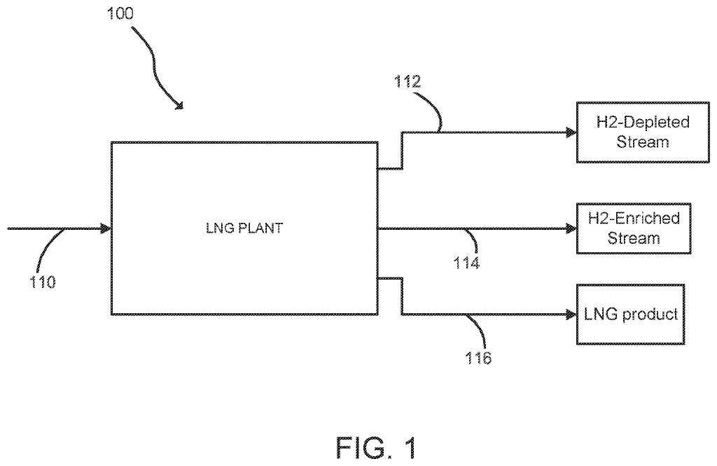

Referring again to FIG. 1, there are three places where hydrogen in the feed gas 110 can potentially go in an LNG liquefaction plant 100. One option (Option A) is to leave hydrogen in the LNG product 116. A second option (Option B) is to use the hydrogen for at least part of the fuel requirements for the system 100, typically as fuel for gas turbines driving refrigerant compressors. The third option (Option C) is to export hydrogen from the system 100, typically for further purification as hydrogen product or returned to a natural gas pipeline downstream from the liquefier. Option A is not practical for natural gas feed with hydrogen in excess of a few hundred PPM, due to the cold liquefaction temperatures required. For both Option B and Option C, stream 114 may be created to transfer hydrogen to the fuel consumer (Option B) or export destination (Option C). Stream 112 may satisfy additional fuel requirement or may be recycled to the natural gas feed 110 or to another location within the LNG plant.

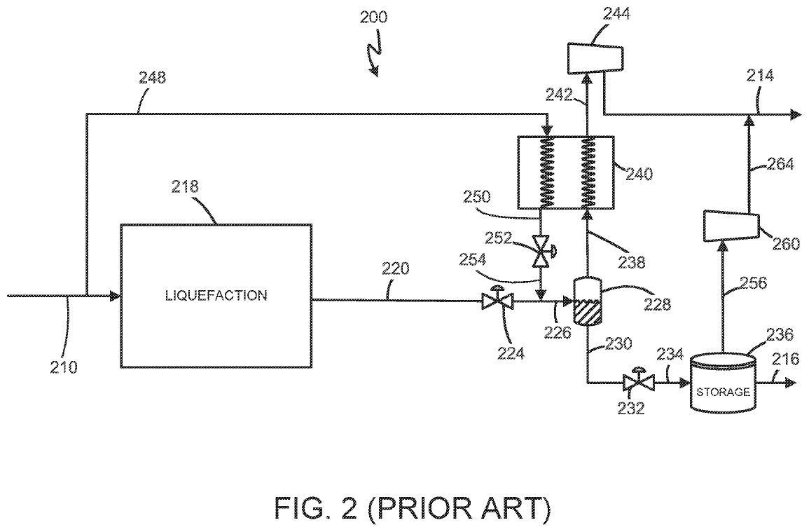

FIG. 2 shows a conventional natural gas LNG system 200. In system 200, a hydrogen-containing natural gas feed stream 210 is cooled and liquefied in a liquefaction unit 218 using a liquefaction process such as conventional C3MR, DMR, SMR, pure component cascade, reverse Brayton cycle or other liquefaction method to form a liquefied natural gas stream 220. Stream 210 may be at a pressure from 30 bara to 80 bara or higher, and at near ambient temperature or precooled to a temperature from −30 degrees C to −60 degrees C by a precooling system. Stream 220 may be at a pressure from 30 bara to 70 bara or higher, and at a temperature from −130 degrees C to −155 degrees C or colder. The liquefied natural gas stream 220 is expanded through a valve 224 to form an expanded LNG stream 226. The liquefied natural gas stream 220 may optionally be passed through a hydraulic turbine (not shown) before being expanded through the valve 224. The optional inclusion of a hydraulic turbine is applicable to all exemplary implementations described herein.

The expanded LNG stream 226 is then separated in an endflash drum 228 into an endflash stream 238 (which is enriched in hydrogen relative to the feed stream 210), and an LNG stream 230 (which is depleted in hydrogen relative to the feed stream 210). In this exemplary implementation, the pressure of the endflash drum 228 is fixed, for example, at fixed pressure between 1.0 bara and 1.5 bara. The LNG stream 230 is expanded via an expansion valve 232 and the expanded LNG stream 234 flows into an LNG storage tank 236. Stream 230 may be pumped to a higher pressure such as 7 bara to 10 bara before valve 232. Valve 232 may be part of the storage tank inlet manifold, such as a spray nozzle or nozzles. An LNG product stream 216 is withdrawn from the storage tank.

The endflash stream 238 is optionally warmed in an endflash heat exchanger 240 against a portion 248 of the hydrogen-containing natural gas feed stream 210 to form a warmed endflash stream 242 and a cooled portion 250. The cooled portion 250 is then expanded through an expansion valve 252 to form an expanded stream 254 which is combined with the expanded LNG stream 226.

The warmed endflash stream 242 is compressed in an endflash compressor 244 to form a fuel stream 214, which is used as fuel in the system 200. In many applications, the fuel stream 214 will be used as fuel for gas turbines that directly drive refrigeration compressors or generate electricity used to power electric motors that drive refrigeration compressors (not shown) for the refrigerants that provide the refrigeration duty for the liquefaction unit 218.

A boil off gas (“BOG”) stream 256 is withdrawn from the LNG storage tank 236 and is compressed in a BOG compressor 260 to form a compressed boil off gas stream 264, which is fed into the fuel stream 214. Stream 256 may comprise vapor generated from the expansion of stream 230, vapor generated from heat leak into stream 234, and vapor generated from heat leak into the storage tank.

### Option A—Hydrogen in LNG Product

The thermodynamics of vapor and liquid equilibrium limits the practicality of having the hydrogen leave the plant in the LNG product. It should be noted that the maximum amount of hydrogen that can be dissolved in the LNG product is about 700 ppm. Therefore, it is only feasible to operate the system 200 with very low hydrogen concentration (well under 1% hydrogen) in the LNG product stream 216. Moreover, doing so will increase the specific power consumption of the system 200. Another barrier is that many existing baseload LNG and peak-shaving plants have limited installed refrigeration power. Most baseload facilities are limited by the installed gas turbine driver power. Peak-shaving, small, and mid-scale plants are usually powered by electric motors. The increase in liquefaction specific power with the addition of a few hundred ppm of hydrogen will reduce the production from facilities that are currently limited by installed power equipment. Therefore, for the system 200, Option B (fuel) and Option C (hydrogen removal), are the only realistic flow paths for hydrogen when there is a concentration greater than several hundred ppm of hydrogen in the feed.

### Option B—Hydrogen in Gas Turbine Fuel

For an existing gas turbine-driven plant, Option B has the advantage of reducing plant carbon intensity since the hydrogen will replace some of the methane content in the fuel. However, this solution may require major modifications to the plant fuel system.

Hydrogen, which is more volatile than methane, will be concentrated in the flash (fuel) gas stream 238. In LNG plants with typical fuel demand, 1% hydrogen in the feed will result in a fuel having greater than 15% hydrogen. With 5% hydrogen in the feed, the hydrogen content in the fuel will exceed 50%.

This change in composition will impact the performance and operability of end flash gas compressor 244, which raises the fuel pressure from near atmospheric to approximately 40 bara. Note that the work required to compress a mole of hydrogen is 3% greater than the work required to compress a mole of methane. In addition, since the lower heating value of hydrogen is lower than methane by a factor of 3.3, more fuel flow is needed to maintain the same fuel heating value to gas turbines to maintain the amount of power available for refrigeration compressors. Overall, this means that the power required to compress any hydrogen in the fuel is higher by a factor of 3.4 compared to the equivalent amount of displaced methane, thereby impacting overall plant power consumption. For an existing plant, substantial modifications to the fuel system—including rotating equipment and static equipment—will likely be required if the feed hydrogen exceeds 0.5%.

In addition to issues with endflash compression, the fuel can also cause operational issues with the gas turbines: most existing industrial frame gas turbines equipped with dry low emissions (DLE) combustion systems are not designed to operate on fuel with a hydrogen concentration greater than 30%. In order to operate at higher hydrogen concentrations, extensive engine and package retrofits are required. Turbines that are already equipped with diffusion combustion systems still require additional fuel blending hardware and package safety upgrades; these turbines may also struggle to keep unabated exhaust NOx emissions within permissible limits when running on higher amounts of hydrogen. In many LNG plants, this will limit implementation of Option B to feeds with less than 2% hydrogen in the feed to keep the hydrogen concentration in the fuel less than 30%.

### Option C—Hydrogen Exported

For LNG plants with gas turbines and greater than 2% hydrogen in the natural gas feed, and for those refrigeration processes with electric motor drives that draw power from the grid, rejecting hydrogen from the system may be an attractive option. The hydrogen can either be reinjected into the natural gas pipeline or it can be sent as a crude hydrogen stream to be further purified to product/hydrogen-pipeline purity. Existing electric motor-driven plants with power provided from the grid have very low fuel demand, so Option C is the only solution available to maintain 100% LNG production when the feed hydrogen content increases beyond about 100 ppm. As will be discussed further, Option C also has significant advantages for gas turbine-driven plants since the modifications required for existing equipment are less extensive than those required for Option B. Optionally, the purified hydrogen stream could be sent to a hydrogen fuel cell, which could be used to generate electricity.

### Flow Schemes Evaluated

To assess the impact of hydrogen blended into natural gas pipelines on downstream LNG plants, several different flow schemes using Options B (hydrogen as fuel) and C (hydrogen exported) have been evaluated. The study baseline is a generic C3MR liquefaction unit using two industrial frame gas turbine drivers producing about 5 million metric tonnes/yr (MTPA) LNG, assuming typical US Gulf Coast ambient conditions and feed gas composition, with a fuel demand of 460 MW LHV basis. The evaluation assumes modifications to an existing plant to process the hydrogen-containing feed; however, the results can be extrapolated to new plants. Comparative results for some of the flow schemes evaluated are shown herein.

Solutions for electric motor-driven peak shaver plants have been evaluated as well. These plants generally have very low fuel demand and will need options for exporting the hydrogen in some form.

Detailed rating simulations of the generic C3MR liquefaction unit were used to evaluate options for processing feed hydrogen concentrations up to 18%. Propane and mixed refrigerant compressor performance was evaluated using compressor curves, and the heat transfer and pressure drop performance of the coil-wound main cryogenic heat exchanger (MCHE) were evaluated using a detailed model. The equipment associated with the endflash and boil-off gas (BOG) systems was evaluated using simple models, with the results compared to the base case of 0% hydrogen in the feed.

Propane and mixed refrigerant power available from the two industrial frame gas turbine refrigeration compression drivers was fixed at the design (base case) values. A parallel driver configuration was assumed with duplicate propane and mixed refrigerant compressors on each driver. Simulations were run to maximize production subject to the constraints of refrigeration driver power available and fuel demand.

For Option B, where hydrogen from the feed is sent to fuel, the flow schemes are designed to concentrate hydrogen in the fuel stream while maximizing LNG production. It was assumed in the study that the fuel efficiency of the gas turbines remains the same and is not a function of hydrogen in the fuel. In each case, it was assumed that the only fuel demand was that of the gas turbines, and that a maximum of 95% of the fuel would be provided by endflash and BOG. For option B schemes, this fuel balance constraint necessitates concentrating hydrogen in the fuel stream to not exceed the fuel demand and suppressing methane flash or recycling of methane as needed.

### Scheme B1—No Flowsheet Modification

For Scheme B1 the system 200 of FIG. 2 was used with no modifications to the existing flowsheet. The endflash drum 228 pressure was fixed at the base case value of 1.24 bara.

### Scheme B2—Bog Recycle

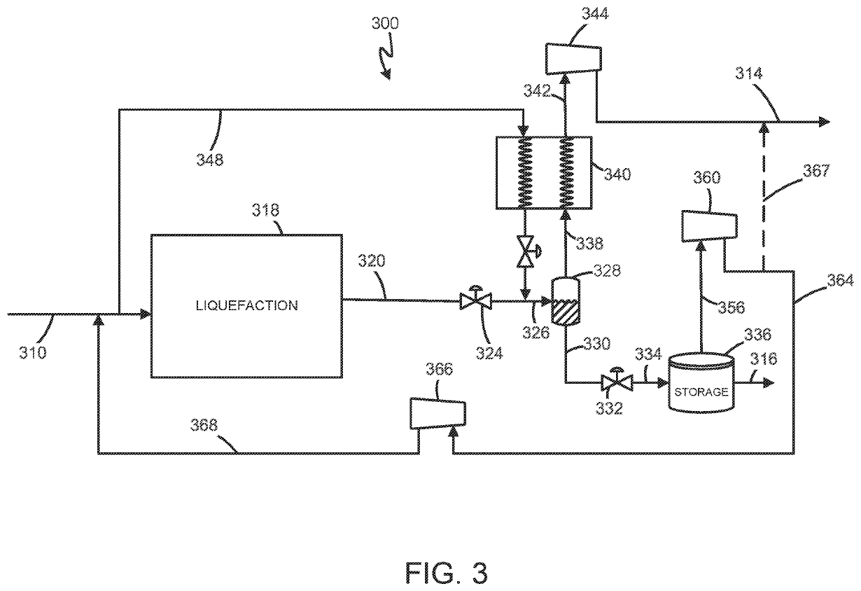

In Scheme B2, illustrated in FIG. 3, an LNG system 300 is shown. In system 300, elements shared with system 200 are represented by reference numerals increased by a factor of 100. For example, the endflash drum 228 of system 200 corresponds to the endflash drum 328 of system 300. In the interest of clarity, some features of system 300 that are identical to corresponding elements of system 200 are numbered in FIG. 3, but are not specifically referred to in the specification. It should be noted that system 300 may be structurally similar to existing LNG systems but, as described below, is operated differently in order to accommodate hydrogen in the feed stream 310.

In system 300, the pressure of the endflash drum 328 is adjustable, which enables the hydrogen concentration in the fuel stream 314 to be controlled to maintain the hydrogen concentration in the endflash stream 338 (which becomes the fuel stream 314) within a predetermined range. Adjustment/control of the pressure in the endflash drum 328 may be provided by adjusting the vapor flow rate drawn through the endflash compressor 344. Means of adjusting the vapor flow rate through compressor 344 include compressor recycle, speed control, inlet guide vanes, compressor suction throttling, or other known methods. The pressure of the endflash drum 328 may be increased to suppress the flash of methane and increase the concentration of hydrogen in the fuel stream 314. The increase in pressure of the endflash drum 328 will result in increased flash in the LNG storage tank 336. To compensate for this increase, at least a first portion 364 of the compressed boil off gas stream is recycled and combined with the hydrogen-containing natural gas stream 310 upstream from the liquefaction unit 318. To match the pressure of the hydrogen-containing natural gas stream 310, the compressed boil off gas stream 364 is further compressed in a BOG recycle compressor 366 to form a further compressed BOG stream 368, which is combined with the hydrogen-containing natural gas stream 310. Optionally, a second portion 367 of the compressed boil off gas stream 364 may be added into the fuel stream 314, thereby providing an additional means to control the hydrogen concentration in the fuel stream 314. These measures may be implemented for the purpose of maintaining a desired heating value in the fuel stream 314.

### Scheme B3—Hydrogen Removal Using a Membrane Stage

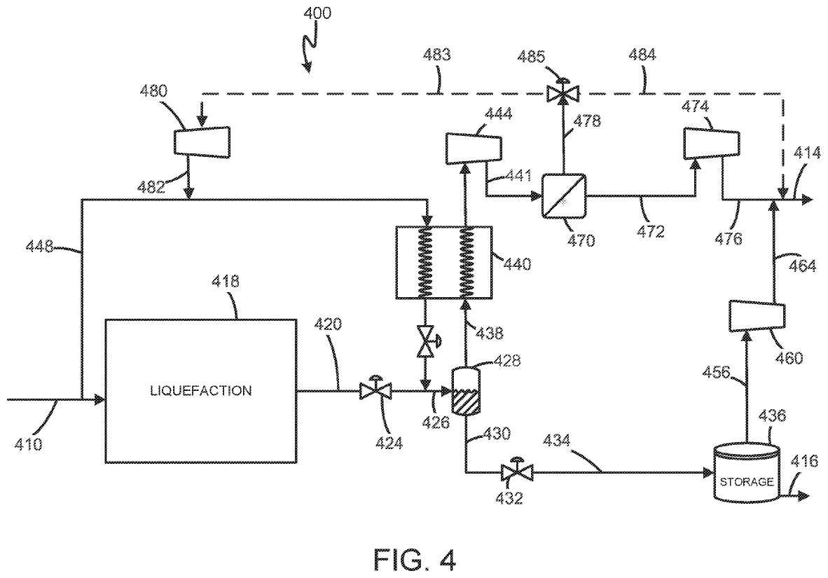

In Scheme B3, illustrated in FIG. 4, an LNG system 400 is shown in which a membrane stage 470 is used to remove hydrogen from a compressed endflash stream 441. In system 400, elements shared with system 200 are represented by reference numerals increased by a factor of 200. For example, the endflash drum 228 of system 200 corresponds to the endflash drum 428 of system 400. In the interest of clarity, some features of system 400 that are identical to corresponding elements of system 200 are numbered in FIG. 4, but are not specifically referred to in the specification.

In system 400, the membrane stage 470 is located downstream from the endflash compressor 444. The membrane stage 470 could comprise one or more membrane modules arranged in parallel. The permeate stream 472 from the membrane stage 470 is enriched in hydrogen and is further compressed in a hydrogen compressor 474 to form a compressed permeate stream 476, which forms at least part of the fuel stream 414. Optionally, the compressed permeate stream may have the highest hydrogen concentration of any stream in the LNG plant 400. Accordingly, at least a portion of the compressed permeate stream may sent to export.

A non-permeate stream 478, which is depleted in hydrogen, may be distributed in one or more ways, depending upon the needs of the system 400. At least a portion 483 of the non-permeate stream 478 may be compressed in an endflash recycle compressor 480 to form a compressed recycle stream 482, which is combined with the portion 448 of the hydrogen-containing natural gas stream 410 upstream from the endflash heat exchanger 440. At least a portion 484 of the non-permeate stream 478 may be mixed into the fuel stream 414, thereby reducing the concentration of hydrogen in the fuel stream 414. A valve 485 schematically represents a means of controlling flow of the non-permeate stream 478 to the portions 483, 484.

### Scheme C1—Hydrogen Flash Drum

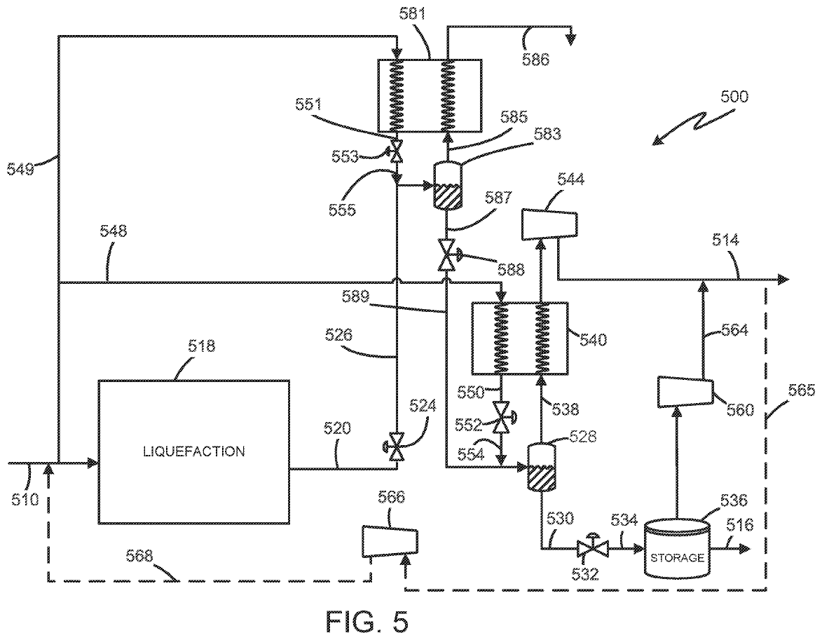

In Scheme C1, illustrated in FIG. 5, an LNG system 500 is shown which is configured to produce a crude hydrogen stream 586 comprising at least 50% mol. hydrogen. The crude hydrogen stream 586 may be sent to a hydrogen purification unit to produce product-grade hydrogen for export or returned to the pipeline downstream from the liquefaction unit 518. In system 500, elements shared with system 200 are represented by reference numerals increased by a factor of 300. For example, the endflash drum 228 of system 200 corresponds to the endflash drum 528 of system 500. Similarly, elements shared with system 400 are represented by reference numerals increased by a factor of 100. In the interest of clarity, some features of system 500 that are identical to corresponding elements of systems 200 and/or 400 are numbered in FIG. 5, but are not specifically referred to in the specification.

The expanded LNG stream 526 is first sent to a crude hydrogen flash drum 583. The operating pressure of the crude hydrogen flash drum 583 may be selected to produce a crude hydrogen stream 585 having a hydrogen concentration of at least 50% mol. Refrigeration from the crude hydrogen stream 585 is recovered in a hydrogen flash exchanger 581 to cool a portion 549 of the hydrogen-containing natural gas stream 510 to produce a cooled additional LNG stream 551. The cooled additional LNG stream 551 exits the hydrogen flash exchanger 581, where it is expanded across an expansion valve 553 to form an expanded additional LNG stream 555. The expanded additional LNG stream 555 is combined with the expanded LNG stream 526 and introduced into the crude hydrogen flash drum 583.

An LNG stream 587 from the crude hydrogen flash drum 583 is then expanded across an expansion valve 588 to form an expanded LNG stream 589. The expanded LNG stream 589 is then sent to the endflash drum 528. The remaining elements of the system 500 are very similar to the system 200 of FIG. 2.

### Results

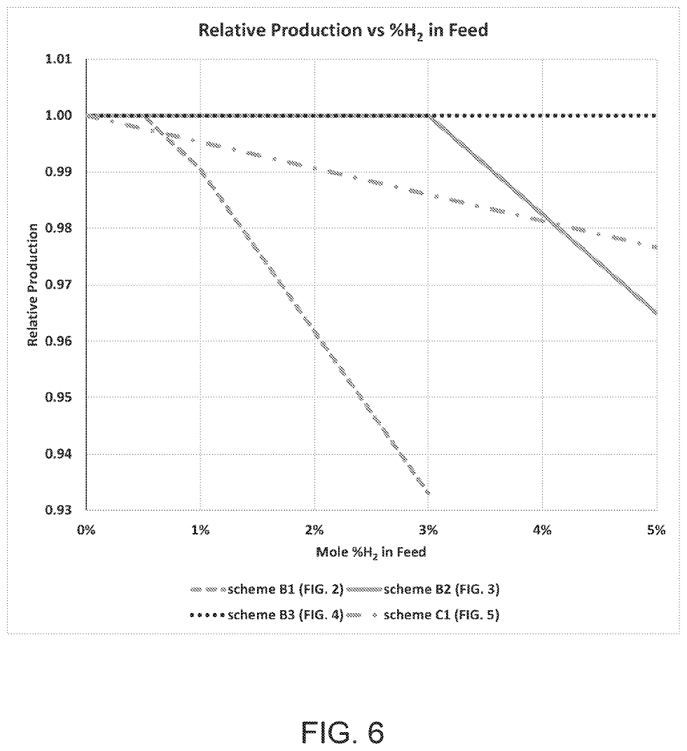

All four schemes were simulated with increasing amounts of hydrogen in the feed. FIG. 6 shows the maximum production available from flow schemes discussed as a function of feed hydrogen content ranging from 0 to 5%. Results are based on simulations having constraints on the power available from the two industrial frame drivers and on the overall plant fuel balance.

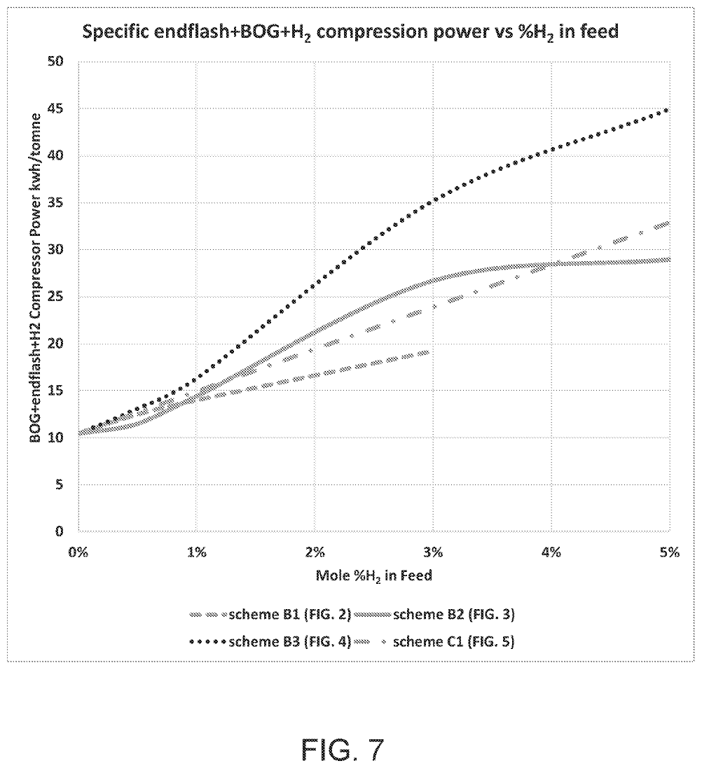

FIG. 7 shows the specific power as kWh per tonne LNG that is consumed by the endflash (244, 344, 444, 544), BOG (260, 360, 460, 560), endflash recycle (480), BOG recycle (366), and hydrogen compressors (474). Power available for the endflash and BOG compressors was not constrained to the base case values, and it was assumed those compressors would be modified or replaced as needed to maximize production. The power required for these electric motor driven compressors did not factor into the fuel balance. Only the refrigerant drivers were considered in fuel requirement calculations.

### Scheme B1—No Flowsheet Modification

Maintaining the desired vapor flow rate from the endflash drum 228 at an existing LNG plant requires a significant decrease in production without the addition of new equipment. This is because the liquefied natural gas stream 220 exiting the liquefaction unit 218 must become colder to suppress flash, so as not to exceed the fuel requirement and remain in fuel balance. For example, the endflash vapor heating value (energy/time, e.g. Btu/s or MW) generated with 3% hydrogen in the feed may be 88% higher than that generated with 0% hydrogen in the feed, for the same liquefaction unit outlet temperature and endflash drum pressure. At 3% hydrogen in the feed, the necessary reduction in liquefaction unit outlet temperature to maintain the same fuel stream heating value as with 0% hydrogen in the feed results in a production decrease of 6.7% at the fixed driver power.

FIG. 7 shows that for 3% hydrogen in the hydrogen-containing natural gas feed stream 210, the power consumed by the endflash and BOG compressors 244, 260 is nearly doubled with respect to the base case (no hydrogen in the feed stream 210). The bulk of the increase is due mainly to an increase in endflash compressor 244 power. For as little as 0.5% hydrogen in the feed, the endflash compressor 244 will require modifications to accommodate the lower molecular weight and increased volumetric flow of the resulting endflash stream 238. An aerodynamic re-rate—including impeller alterations or an increase in rotational speed—may be accompanied by a more powerful drive motor. At hydrogen concentrations above 0.5% in the hydrogen-containing natural gas feed stream 210, the endflash compressor 244 will need to be replaced or supplemented with a new parallel compression string.

### Scheme B2—BOG Recycle

For this configuration, pressure of the endflash drum 328 is controlled to reduce flashing, adding another operational degree of freedom in maintaining proper fuel balance, thereby allowing the plant to achieve 100% LNG production for concentrations up to ˜3% hydrogen in the hydrogen-containing natural gas stream 310 (FIG. 3). This recovered production, however, comes at additional operating cost: note that in FIG. 7 the power consumed by back-end compression—consisting of the endflash gas compressor 344, BOG compressor 360, and an additional BOG recycle compressor 366 in this scheme—is more than two times the base case for 3% hydrogen in the hydrogen-containing natural gas stream 310. There is a large increase in required BOG compression power because the higher endflash drum 328 pressure shifts adiabatic flash from the endflash drum 328 to the storage tank 336. Above 3% hydrogen in the feed, 100% design LNG production is not possible with this scheme for the study conditions.

### Scheme B3—Hydrogen Removal Using a Membrane Stage

In this scheme, membrane stage 470 is added to concentrate hydrogen in the fuel stream 414. This scheme allows for 100% LNG production at 5% hydrogen in the hydrogen-containing natural gas stream 410 but at a higher operating cost. Note that the hydrogen compressor 474 power to compress the permeate stream 472 is included in FIG. 7.

In addition to the new endflash recycle compressor 480, membrane stage, and permeate hydrogen compressor 474, the existing endflash compressor 444 will also have to be modified or replaced at higher hydrogen concentrations because of significant differences in the new operating conditions.

With significant plant modifications, both Schemes B2 and B3 can make the original design LNG production at 3% hydrogen in the hydrogen-containing natural gas stream 310, 410. However, the resulting fuel stream 314, 414 to the turbine contains 40% hydrogen by volume. The current class of industrial frame gas turbine drivers are not designed to operate with concentrations of hydrogen greater than 30% when equipped with dry low emissions (DLE) combustion systems, while turbines with diffusion combustion systems may require additional NOx abatement hardware. Turbines must undergo a materials and package safety review to assess high hydrogen concentrations in the fuel system; the OEM of the gas turbine should be consulted for fuel compositions greater than 10% hydrogen.

For both FIGS. 3 and 4 the hydrogen enriched stream (338, 472) could be exported as crude hydrogen or sent to a purification unit and exported as hydrogen product, instead of being sent to the fuel stream. Fuel requirements, if any, could then be satisfied by the hydrogen depleted stream (367, 478).

### Scheme C1—Hydrogen Flash Drum

In Scheme C1, hydrogen is rejected in a stream containing 50% (molar) hydrogen (crude hydrogen stream 585). This crude hydrogen stream 585 may be sent for further purification to product grade hydrogen or sent back to the pipeline.

The production, shown in FIG. 6, reduces with increasing hydrogen content in the hydrogen-containing natural gas stream 510, reaching about 2% reduction at 5% hydrogen in the feed. This production loss is mainly due to the loss of refrigeration provided by an LNG hydraulic turbine (not shown). As hydrogen in the feed increases, the discharge pressure of the turbine is increased to prevent vapor from forming in the turbine. At 5% hydrogen the discharge pressure approaches the inlet pressure, and the turbine is bypassed. This loss in production could, however, be eliminated by adding an endflash recycle compressor 566 (dashed line).

This scheme minimizes the required alterations to an existing LNG plant and the downtime required to implement them. For electric motor-driven LNG plants with low fuel consumption, hydrogen rejection from the process is the only feasible solution among those evaluated for feed hydrogen content above 200-500 PPM.

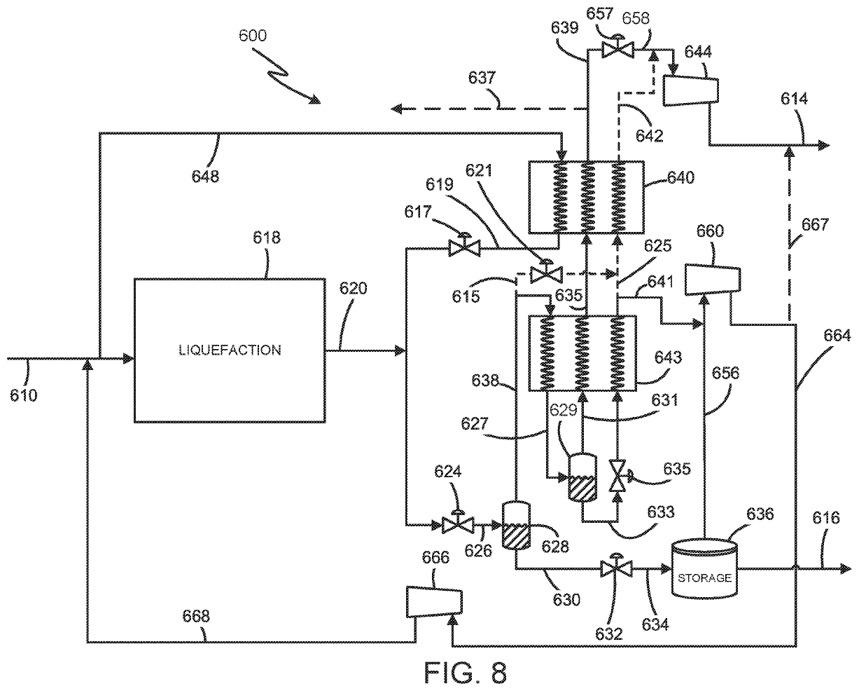

FIG. 8 shows another illustrative implementation of an LNG system 600, in which a hydrogen cold box is provided. In system 600, elements shared with system 200 are represented by reference numerals increased by a factor of 400. For example, the endflash drum 228 of system 200 corresponds to the endflash drum 628 of system 600. Similarly, elements shared with system 300 are represented by reference numerals increased by a factor of 300. For example, the recycle compressor 366 of system 300 corresponds to the BOG recycle compressor 666 of system 600. In the interest of clarity, some features of system 600 that are identical to corresponding elements of systems 200 and/or 300 are numbered in FIG. 8, but are not specifically referred to in the specification.

In system 600, endflash drum 628 is operated at a pressure from 1.5 bara to 55 bara. The hydrogen enriched vapor 638 from endflash drum 628 is cooled and partially liquefied in heat exchanger 643. The two-phase mixture 627 is separated in separator 629 into a further hydrogen enriched vapor 631 and a methane enriched liquid 633. The further hydrogen enriched vapor is warmed in heat exchanger 643 and endflash exchanger 640 to form a crude hydrogen product 637. The crude hydrogen product can be reinjected to the natural gas pipeline or further purified to make a pure hydrogen product.

The methane enriched liquid 633 is expanded in valve 635 and warmed in heat exchanger 643 to make intermediate methane stream 641 which is then sent to BOG compressor 660. At least a portion 625 of the intermediate methane stream 641 may be warmed in endflash exchanger 640 to make warmed methane enriched vapor 642 and compressed in endflash compressor 644 to form fuel stream 614. At least a portion 639 of crude hydrogen product 637 may be combined with the warmed methane enriched vapor 642 to provide additional fuel. At least a portion 615 of the hydrogen enriched vapor 638 may bypass the heat exchanger 643 to at least a portion of intermediate methane stream 625.

The LNG stream 630 is sent to the storage tank. BOG stream 656 and intermediate methane stream 641 are compressed in BOG compressor 660 to form a compressed boil off gas stream 664 which may be compressed in BOG recycle compressor 666 to form a further compressed BOG stream 668, which is combined with the hydrogen-containing natural gas feed stream 610. At least a portion 667 of the compressed boil off gas stream 664 may be sent to fuel stream 614.

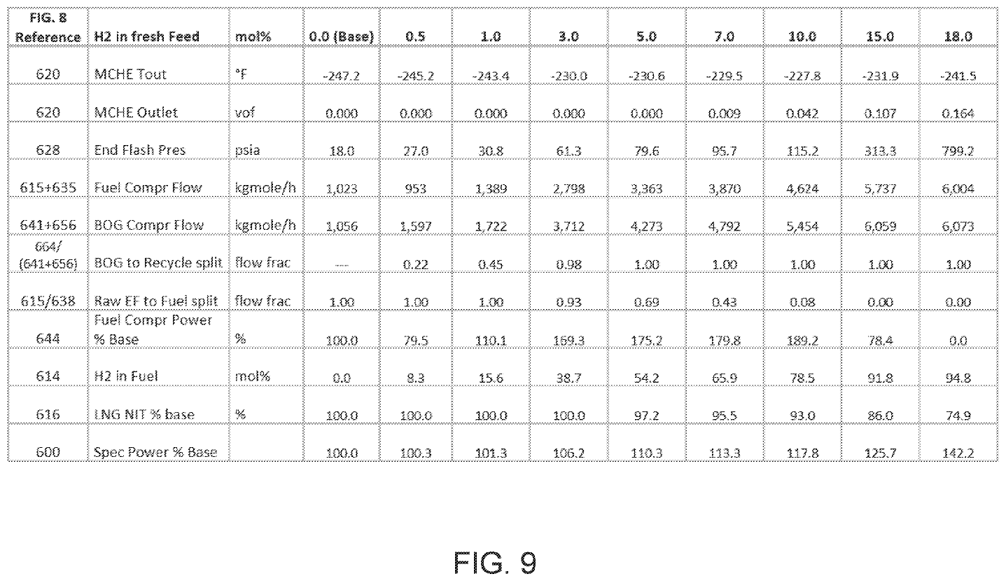

FIG. 9 is a table showing modeled system parameters for the exemplary implementation of FIG. 8 for a range of hydrogen concentrations in the feed gas stream 610. Note that the temperature of the LNG stream 620 is the warmest when the hydrogen concentration in the feed gas stream 610 is 10%. Also notable is the LNG production begins to drop when the hydrogen concentration in the feed gas stream 610 is above 3%.

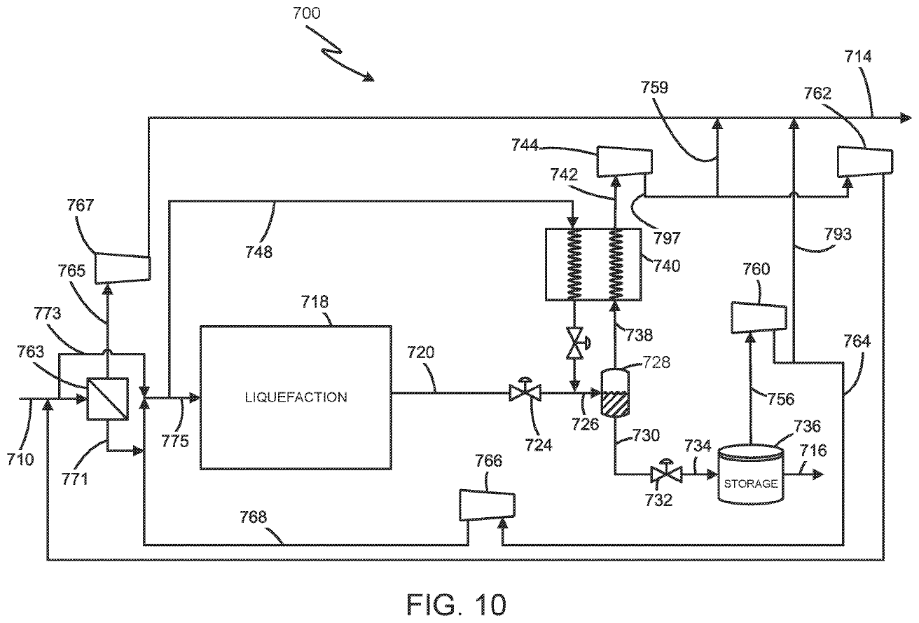

FIG. 10 shows another illustrative implementation of an LNG system 700, in which the feed gas stream 710 is pretreated to remove some hydrogen from the gas stream prior to liquefaction. In system 700, elements shared with system 200 are represented by reference numerals increased by a factor of 500. For example, the endflash drum 228 of system 200 corresponds to the endflash drum 728 of system 700. Similarly, elements shared with system 300 are represented by reference numerals increased by a factor of 400. For example, the recycle compressor 366 of system 300 corresponds to the recycle compressor 766 of system 700. In the interest of clarity, some features of system 700 that are identical to corresponding elements of systems 200 and/or 300 are numbered in FIG. 10, but are not specifically referred to in the specification.

In system 700, the feed gas stream 710 is passed through a membrane module 763 before liquefaction to form a hydrogen enriched permeate stream 765 and a hydrogen-depleted non-permeate stream 771 which may be liquefied in liquefaction unit 718 with lower power consumption than would be required for liquefying the feed gas stream 710. A bypass stream 773 is provided to enable the membrane module 763 to be bypassed when the hydrogen concentration in the feed gas stream 710 is sufficiently low that pre-liquefaction hydrogen removal is not needed. The hydrogen-depleted non-permeate stream 771 is combined with the further compressed BOG stream 768 upstream from liquefaction. The hydrogen enriched permeate stream 765 is compressed in compressor 767 to form the fuel stream 714. A portion 759 of a warmed compressed endflash stream 797 and a portion 793 of the BOG stream 764 may be combined into the fuel stream 714. The hydrogen enriched permeate stream 765 may alternatively be exported to the natural gas pipeline or further purified to make a hydrogen product.

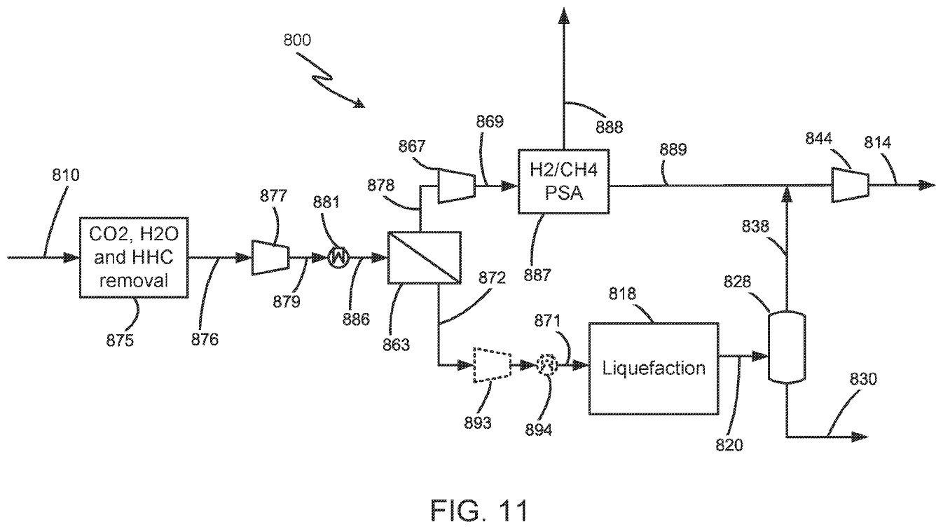

Another exemplary implementation of an LNG plant 800 is shown in FIG. 11. In this LNG plant 800, the feed gas stream 810 is processed in a pretreatment unit 875 to remove CO2, water, and heavy hydrocarbons to produce a pretreated feed gas stream 876. Pretreatment to remove CO2 is typically performed by absorption in an acid-gas removal unit. Water removal may be performed by cooling of the natural gas to promote condensation of bulk water followed by dehydration in an adsorption unit. Heavy hydrocarbon removal may be performed by adsorption, partial condensation, distillation or a combination of those. The pretreated feed gas stream 876 is then compressed in a compressor 877 to produce a compressed pretreated feed gas stream 879, cooled against ambient air heat, cooling water, or another cooling medium such as propane, HFC, or a mixed refrigerant in exchanger 881 to produce a cooled pretreated gas stream 886. The cooled pretreated gas stream 886 is then passed through a membrane module 863 to form a hydrogen enriched permeate stream 878 and a hydrogen depleted non-permeate stream 872. The hydrogen depleted non-permeate stream 872 is optionally compressed and cooled (via compressor 893 and heat exchanger 894) before being liquefied.

The hydrogen enriched permeate stream 878 is then compressed with a compressor 867 to form a compressed hydrogen enriched permeate stream 869. The compressed hydrogen enriched permeate stream 869 is then processed using a pressure-swing adsorption unit 887, which produces a purified hydrogen stream 888 and a hydrogen-depleted stream 889. The purified hydrogen stream 888 may have a hydrogen concentration of at least 90%. The hydrogen depleted stream 889 is combined with the endflash stream 838, which is then compressed using the endflash compressor 844 to produce a fuel stream 814.

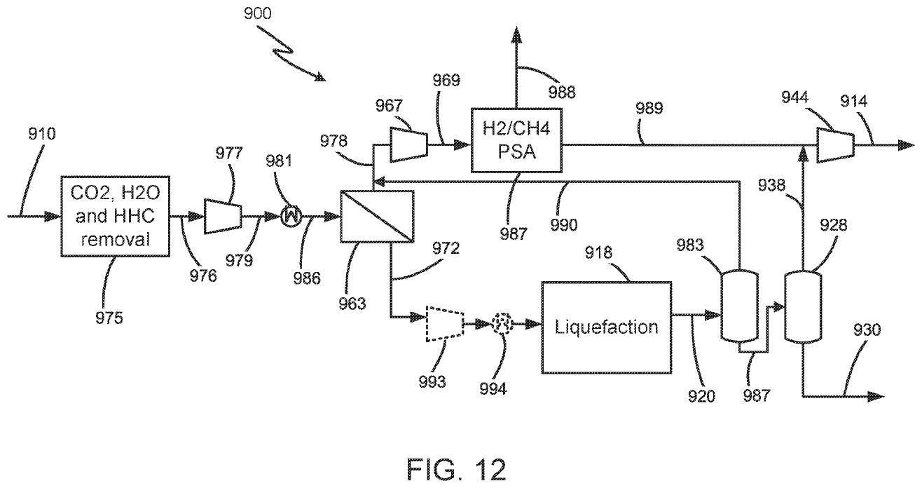

Another exemplary implementation of an LNG plant 900 is shown in FIG. 12. The LNG plant 900 is very similar to the LNG plant 800, with the primary difference being that two endflash drums 983 and 928 are provided in series. An endflash stream 990 from the first endflash drum 983 is combined with the hydrogen enriched permeate stream 978 prior to compression. An LNG stream 987 from the first endflash drum 983 is further separated in a second endflash drum 928. An endflash stream 938 from the second endflash drum 928 is combined with the hydrogen-depleted stream 989 upstream from the endflash compressor 944. An LNG stream 930 from the second endflash drum 928 is then sent to LNG storage (not shown).

The present invention is not to be limited in scope by the specific aspects or embodiments disclosed in the examples, which are intended as illustrations of a few aspects of the invention, and any embodiments that are functionally equivalent are within the scope of this invention. Various modifications of the invention in addition to those shown and described herein will become apparent to those skilled in the art and are intended to fall within the scope of the appended claims.

1. A method comprising:
(a) cooling and liquefying a hydrogen-containing natural gas feed stream in a natural gas liquefaction plant to form a liquefied natural gas stream;
(b) reducing the pressure of the liquefied natural gas stream to form an expanded LNG stream;
(c) separating the expanded LNG stream into a first endflash stream and a hydrogen-depleted LNG stream in a first endflash unit, the first endflash stream having a higher concentration of hydrogen than the hydrogen-containing natural gas feed stream, the hydrogen-depleted LNG stream having a lower concentration of hydrogen than the hydrogen-containing natural gas feed stream; and
(d) further processing the first endflash stream and/or the hydrogen-depleted LNG stream to form a gaseous depleted hydrogen stream and a gaseous enriched hydrogen stream.

2. The method of claim 1, wherein step (d) is performed using at least one selected from the group of: at least one membrane stage, at least one adsorption stage, a partial condensation stage, a distillation stage, a stripping stage, and an electrochemical membrane stage.

3. The method of claim 1, wherein the first endflash unit is a vapor liquid separator.

4. The method of claim 1, wherein the first endflash unit is a distillation column.

5. The method of claim 1, further comprising:
(e) compressing the gaseous enriched hydrogen stream and using it as a fuel stream.

6. The method of claim 5, wherein the fuel stream is for a gas turbine, a boiler, or a fired heater.

7. The method of claim 1, further comprising:
(f) further processing the gaseous enriched hydrogen stream to form a purified hydrogen stream having a hydrogen concentration of at least 90%.

8. The method of claim 7, further comprising:
(g) sending the purified hydrogen stream to a fuel cell to make electricity.

9. The method of claim 7, further comprising:
(h) sending the purified hydrogen stream to a hydrogen pipeline.

10. The method of claim 1, further comprising:
(i) sending at least a portion of the gaseous depleted hydrogen stream to a fuel stream.

11. The method of claim 1, further comprising:
(j) sending at least a portion of the gaseous depleted hydrogen stream to a recycle stream that is combined with the hydrogen-containing natural gas feed stream upstream from step (a).

12. The method of claim 1, further comprising:
(k) controlling the separator pressure at which step (c) is performed in order to maintain a concentration of hydrogen in the first endflash stream within a first predetermined range.

13. The method of claim 1, further comprising:
(1) pretreating the hydrogen-containing natural gas feed stream upstream from step (a) to produce a pretreated hydrogen-containing natural gas feed stream and a hydrogen enriched pretreatment stream, the pretreated hydrogen-containing natural gas feed stream having a lower concentration of hydrogen than the hydrogen-containing natural gas feed stream.

14. The method of claim 13, further comprising:
(m) sending the hydrogen enriched pretreatment stream to a fuel stream.

15. The method of claim 13, further comprising:
(n) performing step (a) on the pretreated hydrogen-containing natural gas feed stream.

16. The method of claim 13, further comprising:
(o) purifying the hydrogen enriched pretreatment stream to form a purified hydrogen stream having a hydrogen concentration of at least 90%.

17. The method of claim 16, further comprising performing step (o) using at least one adsorption bed.

18. A method comprising:
(a) cooling and liquefying a hydrogen-containing natural gas feed stream in a natural gas liquefaction plant having at least one gas turbine-driven refrigeration compressor to form a liquefied natural gas stream;
(b) using a fuel stream to drive at least one of the at least one gas turbine-driven refrigeration compressor;
(c) reducing the pressure of the liquefied natural gas stream to form an expanded LNG stream;
(d) separating the expanded LNG stream into an endflash stream and a hydrogen-depleted LNG stream in an endflash separator, the endflash stream having a higher concentration of hydrogen that the hydrogen-containing natural gas feed stream;
(e) compressing the endflash stream to form a compressed endflash stream;
(f) storing the hydrogen-depleted LNG stream in an LNG storage tank;
(g) compressing a BOG stream from the LNG storage tank to form a compressed BOG stream;
(h) further compressing the compressed BOG stream to form a further compressed BOG stream; and
(i) combining the further compressed BOG stream with the hydrogen-containing natural gas feed stream upstream from the performance of step (a);
wherein the fuel stream comprises the compressed endflash stream.

19. The method of claim 17, further comprising:
(j) diverting a first portion of the BOG stream upstream from step (h); and
(k) combining the first portion of the BOG stream with the endflash stream to form the fuel stream.

20. A method comprising:
(a) cooling and liquefying a hydrogen-containing natural gas feed stream in a natural gas liquefaction plant to form a liquefied natural gas stream;
(b) reducing the pressure of the liquefied natural gas stream to form an expanded LNG stream;
(c) separating the expanded LNG stream into a first endflash stream and a hydrogen-depleted LNG stream in a first endflash unit, the first endflash stream having a higher concentration of hydrogen than the hydrogen-containing natural gas feed stream, the hydrogen-depleted LNG stream having a lower concentration of hydrogen than the hydrogen-containing natural gas feed stream;
(d) compressing the endflash stream using an endflash compressor to form a compressed endflash stream;
(e) using the compressed endflash stream as a fuel stream; and
(f) controlling the pressure at which the endflash compressor is operated to maintain a hydrogen concentration in the fuel stream within a predetermined range.
